(19) United States
(12) Patent Application Publication
(10) Pub. No.: US 2026/0156065 A1
(43) Pub. Date: Jun. 4, 2026

(54) CROWD-SOURCED INTELLIGENCE FOR CABLE MODEM NETWORKS

(71) Applicant: MaxLinear, Inc., Carlsbad, CA (US)

(72) Inventors: Saju Palayur, Poway, CA (US); Mark Rudek, Rishon Le Zion (IL); Artur Borukhov, Petah Tikva (IL); Ran Konforti, Petah Tikva (IL); Noga Kaspi-Yanay, Petah Tikva (IL)

(73) Assignee: MaxLinear, Inc., Carlsbad, CA (US)

(21) Appl. No.: 19/406,684

(22) Filed: Dec. 2, 2025

Related U.S. Application Data
(60) Provisional application No. 63/727,183, filed on Dec. 2, 2024.

(51) Int. Cl. H04L 43/16; H04L 12/28; H04L 43/08

(52) U.S. Cl. CPC H04L 43/16; H04L 12/2801; H04L 43/08

(57) ABSTRACT

A modem may include a processing device. The processing device may monitor, at the modem, a downstream spectrum for performance data. The processing device may determine, at the modem, when the performance data is greater than a threshold. The processing device may send, from the modem to a converged cable access platform (CCAP) core, the performance data when the performance data is greater than the threshold.

### RELATED APPLICATION

This application claims the benefit of U.S. Provisional Application No. 63/727,183, filed Dec. 2, 2024, the disclosure of which is incorporated herein by reference in its entirety.

The examples discussed in the present disclosure are related to crowd-sourced intelligence for cable modem networks.

### BACKGROUND

Unless otherwise indicated herein, the materials described herein are not prior art to the claims in the present application and are not admitted to be prior art by inclusion in this section.

Cable modems may be used to deliver broadband internet access in the form of cable internet. A cable modem may be a network bridge between a customer and a coaxial network. Different standards may be used with cable modems such as Data Over Cable Service Interface Specification (DOCSIS) and/or Multimedia over Coax Alliance (MoCA).

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some examples, a modem may include a processing device. The processing device may monitor, at the modem, a downstream spectrum for performance data. The processing device may determine, at the modem, when the performance data is greater than a threshold. The processing device may send, from the modem to a converged cable access platform (CCAP) core, the performance data when the performance data is greater than the threshold.

In some examples, a CCAP core may include a processing device. The processing device may receive, at the CCAP core from a modem, performance data. The processing device may determine, at the CCAP core, a response based on the performance data.

In some examples, a device may include a tap in a cable modem network that may split and distribute radio frequency signals from a first coaxial cable to one or more subscriber lines in which the tap includes a processing device that may monitor, at the tap, a signal spectrum for noise data. The processing device may apply, at the tap, an adaptive filter to adjust attenuation based on the noise data.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example block diagram for a cable modem architecture.

FIG. 2 illustrates an example artificial intelligence (AI) framework.

FIG. 3 illustrates an example block diagram for a cable modem network tap.

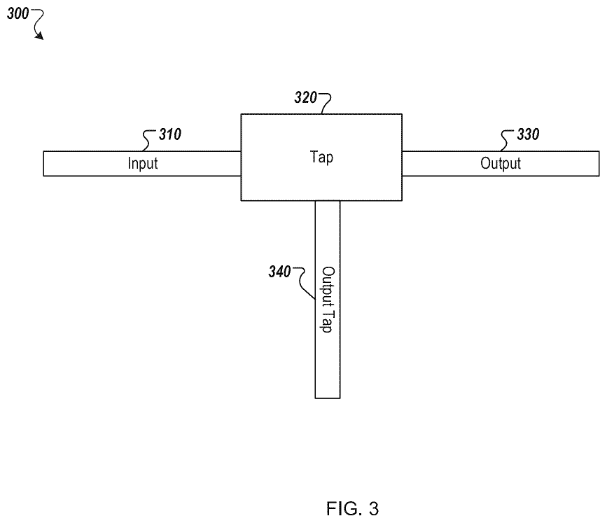

FIG. 4 illustrates an example process flow of a cable modem.

FIG. 5 illustrates an example process flow of a converged cable access platform (CCAP) core.

FIG. 6 illustrates a process flow for a computer readable medium used for cable modem network tap.

FIG. 7 illustrates a block diagram of an example system configured to perform crowd-sourced intelligence for cable modem networks.

FIG. 8 illustrates a diagrammatic representation of a machine in the example form of a computing device within which a set of instructions, for causing the machine to perform any one or more of the methods discussed herein, may be executed.

### DESCRIPTION

Domain-specific machine learning models running on the edge router may reduce the total cost of ownership by enhancing network robustness and efficiency while also enhancing performance and user experience. Artificial intelligence (AI) and machine learning (ML) smart home gateways may enhance three different areas: (1) network optimization and performance, (2) network monitoring and analysis, and (3) user experience and support.

Network optimization and performance may occur in several ways. The quality of service and key performance indicators may be optimized for enhanced performance. Adaptive latency may be reduced for specific apps. Proactive threat detection and intelligent link adaptation may also enhance performance. In addition, AI-enabled smart taps may provide self-healing for noise and/or outage mitigation.

Network monitoring and analysis may involve real-time wide area network monitoring and machine learning analysis. A standardized application protocol interface (API) may be used for edge-cloud interoperability.

User experience and support may be enhanced by using AI-assisted self-installation and fault resolution, intelligent customer support, and actionable AI insights to drive subscriber retained and loyalty.

For cable modem networks, network robustness and efficiency may be increased while also enhancing performance and user experience. In a cable modem network, the converged cable access platform (CCAP) core polls cable modems for proactive network maintenance (PNM) data which may consume bandwidth when issues are infrequent which may lead to inefficiencies and delayed responses.

Therefore, by allowing cable modems to process time-series data locally using AI/ML models to identify patterns or anomalies, network robustness, efficiency, performance, and user experience may be enhanced. In addition, the CCAP core may be interrupted when actionable issues are detected which may reduce bandwidth usage and allow for quicker responses. Communication may occur when a network issue has been identified, which may save bandwidth by avoiding constant polling. There may be a faster detection and escalation of specific network issues. In addition, the modems' computational power may be leveraged which may allow for localized processing and real-time diagnostics.

Examples of the present disclosure will be explained with reference to the accompanying drawings.

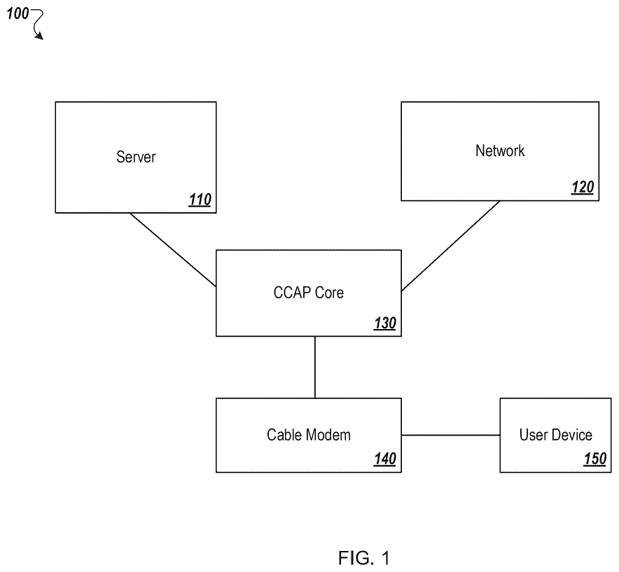

In some examples, FIG. 1 illustrates an example cable network 100 block diagram which may include a server 110, a network 120, a CCAP core 130, a cable modem 140, and/or a user device 150.

A modem (e.g., cable modem 140) may include a processing device. The processing device may: monitor, at the modem, a downstream spectrum for performance data; determine, at the modem, when the performance data is greater than a threshold; and/or send, from the modem to a CCAP core, the performance data when the performance data is greater than the threshold.

The modem may perform spectrum capture and diagnostics. The downstream spectrum may be monitored for performance data such as signal-to-noise ratio variations, interference, and/or channel impairments. These data (e.g., signal-to-noise ratio (SNR) variations, interference, and/or channel impairments) may be used to generate a heatmap to identify recurring network issues in specific areas.

The processing device of the modem (e.g., cable modem 140) may determine, at the modem, when the performance data is greater than the threshold using one or more of an artificial intelligence model or a machine learning model. Various artificial intelligence and/or machine learning models may be used. For example, one or more of machine learning models, deep learning models, generative models, hybrid models, or the like may be used. Different types of machine learning models that may be used include one or more of supervised learning, unsupervised learning, reinforcement learning, or the like. Artificial neural networks, decision trees, support vector machines, regression analysis, Bayesian networks, Gaussian processes, genetic algorithms, belief functions, training models, or the like may be used as models. The models may be trained using any suitable dataset. For example, the models may be trained using historical performance data.

The processing device of the modem (e.g., cable modem 140) may use, at the modem, the performance data to generate an area-wide heatmap. For example, a region having network issues may be identified from the generated heatmap. The heatmap may be generated based on performance data (such as SNR data and interference data).

The processing device of the modem (e.g., cable modem 140) may determine, at the modem, an environmental factor impact based on the performance data. The environmental factor may include one or more of temperature (e.g., during day/night cycles) and/or moisture (e.g., rain, snow, or the like) that may impact the frequency response and attenuation of one or more of installed couplers, splitters, cables, or the like at various distances and for various manufacturer types and/or brands. Time-series analysis may help assess how environmental factors (e.g., temperature cycles, moisture) affect the performance of couplers, splitters, and cables, and historical data may predict failures or degradation to enable proactive alerts and maintain service quality.

The processing device of the modem (e.g., cable modem 140) may adjust, at the modem, one or more of an equalization, a modulation rate, of a signal gain to mitigate the environmental factor. The modem may adjust one or more of the equalization, the modulation rate, or the signal gain autonomously. The modem may adjust one or more of the equalization, the modulation rate, or the signal gain to mitigate environmental effects. The environmental effects may include temperature induced attenuation and/or moisture related signal degradation.

The processing device of the modem (e.g., cable modem 140) may predict, at the modem, one or more of performance degradation or failure based on historical data; and/or send, from the modem to the CCAP core, an alert based on one or more of the performance degradation or the failure. Historical data may be used to predict the failures or the performance degradation. Alerts may be sent and/or preemptive actions may be taken to maintain service quality.

The processing device of the modem (e.g., cable modem 140) may send, from the modem to a CCAP core, the performance data in real time. The performance data (e.g., SNR, bit error ratio (BER), interference data, or the like) may be provided in real time to enhance the efficiency of the response.

The performance data may include any suitable performance data. Examples of performance data include one or more of SNR data, interference data, BER data, modulation error ratio (MER) data, or channel impairment data.

The cable modem network may interface with a cloud computing environment which may allow seamless, secure, and scalable communication between edge devices and cloud services for efficient operations. For example, an artificial intelligence framework may facilitate edge-to-cloud communication for DOCSIS, SmartTap, passive optical network (PON), and Wi-Fi® Gateways, enabling efficient operations. Various data models may be used including internet engineering task force (IETF) data models such as Yet Another Next Generation (YANG) models and Management Information Base (MIB) models. A Network Configuration protocol (NETCONF) design may be used to facilitate efficient configuration and standardization for cloud-based integration. Modular design and security may support data growth with storage compression encryption and deduplication using e.g., a security operations center (SOC), for secure and reliable operations.

The CCAP core may include a processing device. The processing device of the CCAP score may receive, at the CCAP core from a modem, performance data; and determine, at the CCAP core, a response based on the performance data. The processing device may use, at the CCAP core, the performance data to generate an area-wide heatmap. The processing device may determine, at the CCAP core, an environmental factor impact based on the performance data. The processing device may receive, at the CCAP core, the performance data in real time.

The processing device may reallocate, at the CCAP core, one or more channels based on the performance data. For example, the CCAP score may allocate channels based on the aggregated performance data from cable modems. This provides feedback for dynamic channel reallocation. For example, real-time SNR, MER, and interference data may be provided to the CCAP core to enable dynamic channel reallocation based on aggregated performance data from cable modems. The performance data may include one or more of SNR data, interference data, BER data, MER data, channel impairment data, or the like.

Modifications, additions, or omissions may be made to the components of FIG. 1 without departing from the scope of the present disclosure.

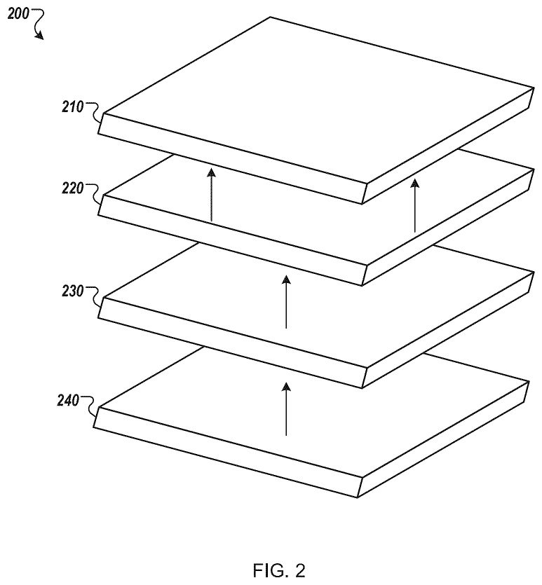

As illustrated in the AI framework 200 in FIG. 2, a standardized algorithm interface 210 may allow for integration of various features. Canned AI/ML recipes 220 may allow for use cases such as virtual reality (VR), extended reality (XR), over the air (OTA), multi-profile, multi-user, machine learning operations, or the like. Firmware and system software 230 may use low-level machine learning aware framework integrated with silicon features. Silicon 240 may be optimized to include one or more of radio, buffers, schedulers, queues, scalable cycles, or the like.

A tap in a cable modem network may split and distribute RF signals from the main coaxial cable to subscriber lines, managing signal strength, minimizing interference, and isolating connections. It enables scalable and reliable service delivery. A smart tap with AI/ML may detect and dynamically notch out noise in real time using adaptive filtering and learning algorithms, enhancing signal quality and network reliability. The smart tap may facilitate proactive noise management, scalability, and reduced operational costs.

As illustrated in FIG. 300, a device 300 may include an input coaxial cable 310, a tap 320, an output coaxial cable 330, and/or an output tap coaxial cable 340. The device may include a tap 320 in a cable modem network to split and distribute radio frequency signals from a first coaxial cable (e.g., input coaxial cable 310) to one or more subscriber lines (e.g., output tap coaxial cable 340).

The tap 320 may include a processing device. The processing device may monitor, at the tap, a signal spectrum for noise data; and apply, at the tap, an adaptive filter to adjust attenuation based on the noise data. The processing device may monitor, at the tap, the signal spectrum using one or more of an artificial intelligence model or a machine learning model. The processing device may detect, at the tap, a noise pattern in the signal spectrum using one or more of an artificial intelligence model or a machine learning model; or classify, at the tap, the noise pattern using one or more of the artificial intelligence model or the machine learning model.

The tap 320 may use AI/ML algorithms to monitor the signal spectrum, detect and classify noise patterns, and learn from historical data to predict and mitigate noise dynamically. The tap 320 may optimize signal quality in real-time by applying adaptive filters and adjusting attenuation based on evolving noise conditions, ensuring a cleaner and more reliable connection for subscribers. The processing device may use, at the tap, historical data to predict and mitigate noise dynamically.

The tap 320 may include a digital signal processor. The digital signal processor may apply an adaptive filter and/or a notch filter. The adaptive filter and/or the notch filter may suppress specific noise frequencies without affecting the rest of the signal.

The tap 320 may be remotely monitored. The tap 320 may be connected to a central management system for real-time performance monitoring, fault detection, and AI model updates to adapt to new noise types.

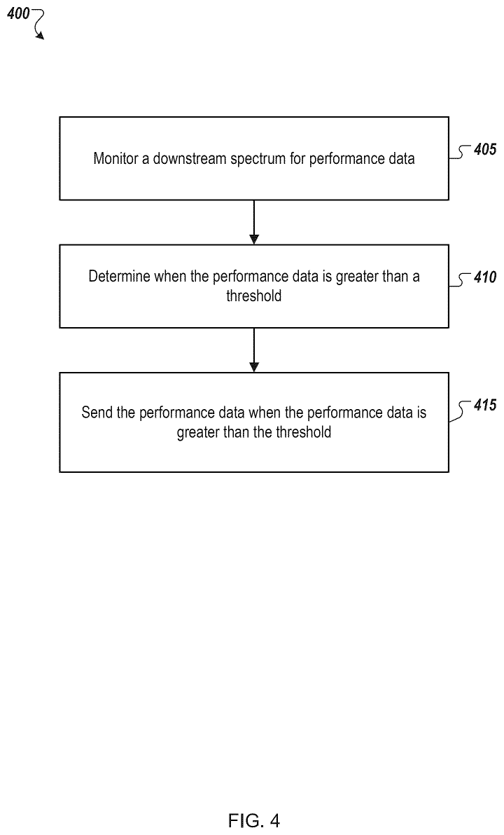

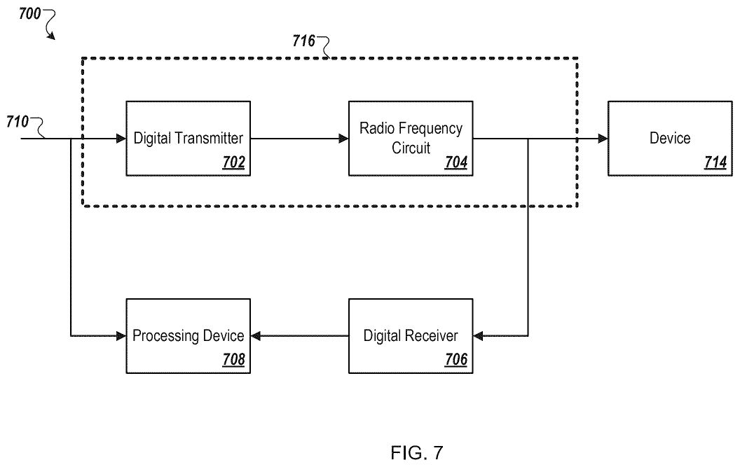

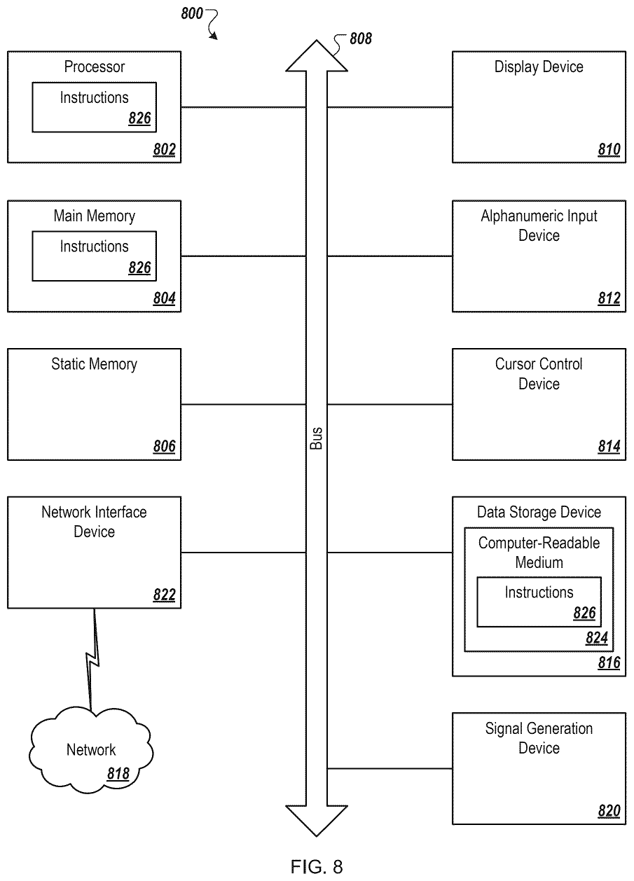

FIG. 4 illustrates a process flow of an example method 400, in accordance with at least one example described in the present disclosure. The method 400 may be arranged in accordance with at least one example described in the present disclosure. The method 400 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 400 may begin at block 405 where the processing logic may monitor, at the modem, a downstream spectrum for performance data.

At block 410, the processing logic may determine, at the modem, when the performance data is greater than a threshold.

At block 415, the processing logic may send, from the modem to a CCAP core, the performance data when the performance data is greater than the threshold.

Modifications, additions, or omissions may be made to the method 400 without departing from the scope of the present disclosure. For example, in some examples, the method 400 may include any number of other components that may not be explicitly illustrated or described.

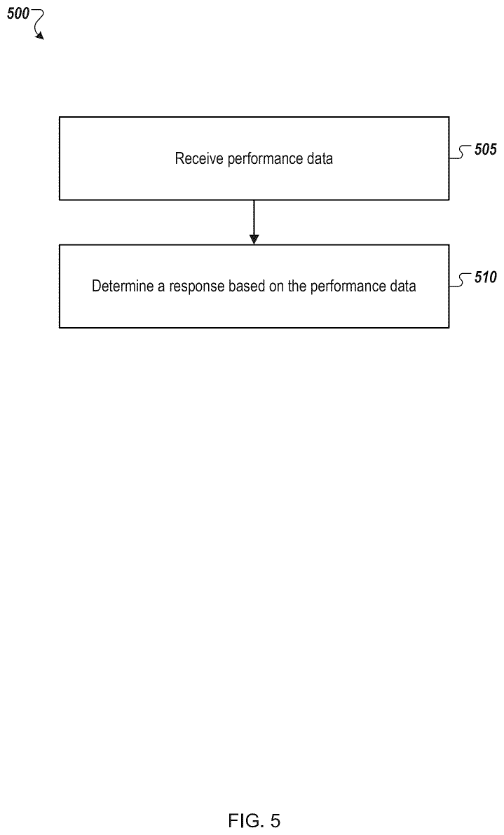

FIG. 5 illustrates a process flow of an example method 500, in accordance with at least one example described in the present disclosure. The method 500 may be arranged in accordance with at least one example described in the present disclosure.

The method 500 may be performed by processing logic that may include hardware (circuitry, dedicated logic, etc.), software (such as is run on a computer system or a dedicated machine), or a combination of both, which processing logic may be included in the processing device 802 of FIG. 8, the communication system 700 of FIG. 7, or another device, combination of devices, or systems.

The method 500 may begin at block 505 where the processing logic may receive, at the CCAP core from a modem, performance data.

At block 510, the processing logic may determine, at the CCAP core, a response based on the performance data.

Modifications, additions, or omissions may be made to the method 500 without departing from the scope of the present disclosure. For example, in some examples, the method 500 may include any number of other components that may not be explicitly illustrated or described.

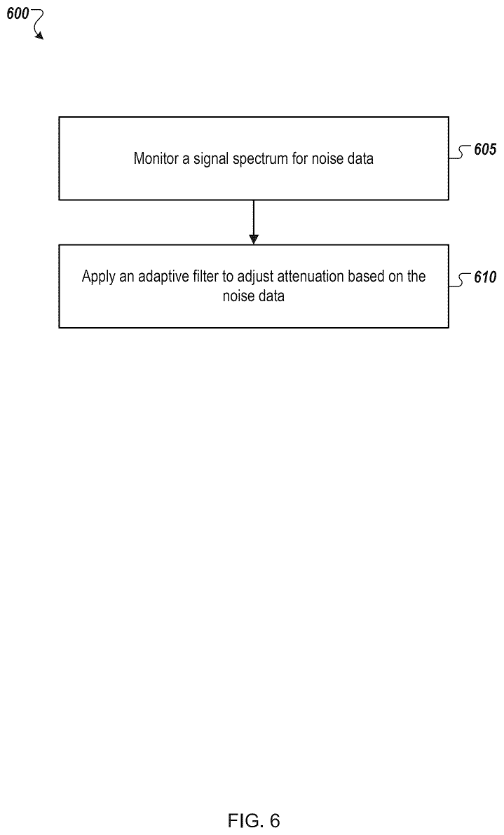

FIG. 6 illustrates a process flow of an example method 600 in accordance with at least one example described in the present disclosure. The method 600 may be arranged in accordance with at least one example described in the present disclosure.

The method 600 may be performed by processing logic that may include hardware (circuitry, dedicated logic, etc.), software (such as is run on a computer system or a dedicated machine), or a combination of both, which processing logic may be included in the processing device 802 of FIG. 11, the communication system 700 of FIG. 7, or another device, combination of devices, or systems.

The method 600 may begin at block 605 where the processing logic may monitor, at the tap, a signal spectrum for noise data.

At block 610, the processing logic may apply, at the tap, an adaptive filter to adjust attenuation based on the noise data.

Modifications, additions, or omissions may be made to the method 600 without departing from the scope of the present disclosure. For example, in some examples, the method 600 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 7 illustrates a block diagram of an example communication system 700 configured for crowd-sourced intelligence for cable modem networks, in accordance with at least one example described in the present disclosure. The communication system 700 may include a digital transmitter 702, a radio frequency circuit 704, a device 714, a digital receiver 706, and a processing device 708. The digital transmitter 702 and the processing device may be configured to receive a baseband signal via connection 710. A transceiver 716 may comprise the digital transmitter 702 and the radio frequency circuit 704.

In some examples, the communication system 700 may include a system of devices that may be configured to communicate with one another via a wired or wireline connection. For example, a wired connection in the communication system 700 may include one or more Ethernet cables, one or more fiber-optic cables, and/or other similar wired communication mediums. Alternatively, or additionally, the communication system 700 may include a system of devices that may be configured to communicate via one or more wireless connections. For example, the communication system 700 may include one or more devices configured to transmit and/or receive radio waves, microwaves, ultrasonic waves, optical waves, electromagnetic induction, and/or similar wireless communications. Alternatively, or additionally, the communication system 700 may include combinations of wireless and/or wired connections. In these and other examples, the communication system 700 may include one or more devices that may be configured to obtain a baseband signal, perform one or more operations to the baseband signal to generate a modified baseband signal, and transmit the modified baseband signal, such as to one or more loads.

In some examples, the communication system 700 may include one or more communication channels that may communicatively couple systems and/or devices included in the communication system 700. For example, the transceiver 716 may be communicatively coupled to the device 714.

In some examples, the transceiver 716 may be configured to obtain a baseband signal. For example, as described herein, the transceiver 716 may be configured to generate a baseband signal and/or receive a baseband signal from another device. In some examples, the transceiver 716 may be configured to transmit the baseband signal. For example, upon obtaining the baseband signal, the transceiver 716 may be configured to transmit the baseband signal to a separate device, such as the device 714. Alternatively, or additionally, the transceiver 716 may be configured to modify, condition, and/or transform the baseband signal in advance of transmitting the baseband signal. For example, the transceiver 716 may include a quadrature up-converter and/or a digital to analog converter (DAC) that may be configured to modify the baseband signal. Alternatively, or additionally, the transceiver 716 may include a direct radio frequency (RF) sampling converter that may be configured to modify the baseband signal.

In some examples, the digital transmitter 702 may be configured to obtain a baseband signal via connection 710. In some examples, the digital transmitter 702 may be configured to up-convert the baseband signal. For example, the digital transmitter 702 may include a quadrature up-converter to apply to the baseband signal. In some examples, the digital transmitter 702 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 702.

In some examples, the transceiver 716 may include one or more subcomponents that may be used in preparing the baseband signal and/or transmitting the baseband signal. For example, the transceiver 716 may include an RF front end (e.g., in a wireless environment) which may include a power amplifier (PA), a digital transmitter (e.g., 702), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 704) of the transceiver 716 may be synchronized with the resource controller via the S-plane device, which may contribute to high-accuracy timing with respect to a reference clock.

In some examples, the transceiver 716 may be configured to obtain the baseband signal for transmission. For example, the transceiver 716 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 716 may be configured to generate a baseband signal for transmission. In these and other examples, the transceiver 716 may be configured to transmit the baseband signal to another device, such as the device 714.

In some examples, the device 714 may be configured to receive a transmission from the transceiver 716. For example, the transceiver 716 may be configured to transmit a baseband signal to the device 714.

In some examples, the radio frequency circuit 704 may be configured to transmit the digital signal received from the digital transmitter 702. In some examples, the radio frequency circuit 704 may be configured to transmit the digital signal to the device 714 and/or the digital receiver 706. In some examples, the digital receiver 706 may be configured to receive a digital signal from the RF circuit and/or send a digital signal to the processing device 708.

In some examples, the processing device 708 may be a standalone device or system, as illustrated. Alternatively, or additionally, the processing device 708 may be a component of another device and/or system. For example, in some examples, the processing device 708 may be included in the transceiver 716. In instances in which the processing device 708 is a standalone device or system, the processing device 708 may be configured to communicate with additional devices and/or systems remote from the processing device 708, such as the transceiver 716 and/or the device 714. For example, the processing device 708 may be configured to send and/or receive transmissions from the transceiver 716 and/or the device 714. In some examples, the processing device 708 may be combined with other elements of the communication system 700.

FIG. 8 illustrates a diagrammatic representation of a machine in the example form of a computing device 800 within which a set of instructions, for causing the machine to perform any one or more of the methods discussed herein, may be executed. The computing device 800 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one example, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 824 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A modem, comprising:
a processing device operable to:
monitor, at the modem, a downstream spectrum for performance data;
determine, at the modem, when the performance data is greater than a threshold; and
send, from the modem to a converged cable access platform (CCAP) core, the performance data when the performance data is greater than the threshold.

2. The modem of claim 1, wherein the processing device is further operable to:
determine, at the modem, when the performance data is greater than the threshold using one or more of an artificial intelligence model or a machine learning model.

3. The modem of claim 1, wherein the processing device is further operable to:
use, at the modem, the performance data to generate an area-wide heatmap.

4. The modem of claim 1, wherein the processing device is further operable to:
determine, at the modem, an environmental factor impact based on the performance data.

5. The modem of claim 4, wherein the processing device is further operable to:
adjust, at the modem, one or more of an equalization, a modulation rate, of a signal gain to mitigate the environmental factor.

6. The modem of claim 1, wherein the processing device is further operable to:
predict, at the modem, one or more of performance degradation or failure based on historical data; and
send, from the modem to the CCAP core, an alert based on one or more of the performance degradation or the failure.

7. The modem of claim 1, wherein the processing device is further operable to:
send, from the modem to the CCAP core, the performance data in real time.

8. The modem of claim 1, wherein the performance data comprises one or more of signal-to-noise ratio (SNR) data, interference data, bit error rate (BER) data, modulation error ratio (MER) data, or channel impairment data.

9. A converged cable access platform (CCAP) core, comprising:
a processing device operable to:
receive, at the CCAP core from a modem, performance data; and
determine, at the CCAP core, a response based on the performance data.

10. The CCAP core of claim 9, wherein the processing device is further operable to:
use, at the CCAP core, the performance data to generate an area-wide heatmap.

11. The CCAP core of claim 9, wherein the processing device is further operable to:
determine, at the CCAP core, an environmental factor impact based on the performance data.

12. The CCAP core of claim 9, wherein the processing device is further operable to:
receive, at the CCAP core, the performance data in real time.

13. The CCAP core of claim 9, wherein the processing device is further operable to:
reallocate, at the CCAP core, one or more channels based on the performance data.

14. The CCAP core of claim 9, wherein the performance data comprises one or more of signal-to-noise ratio (SNR) data, interference data, bit error rate (BER) data, modulation error ratio (MER) data, or channel impairment data.

15. A device, comprising:
a tap in a cable modem network operable to split and distribute radio frequency signals from a first coaxial cable to one or more subscriber lines, wherein the tap comprises a processing device operable to:
monitor, at the tap, a signal spectrum for noise data; and
apply, at the tap, an adaptive filter to adjust attenuation based on the noise data.

16. The device of claim 15, wherein the processing device is further operable to:
monitor, at the tap, the signal spectrum using one or more of an artificial intelligence model or a machine learning model.

17. The device of claim 15, wherein the processing device is further operable to:
detect, at the tap, a noise pattern in the signal spectrum using one or more of an artificial intelligence model or a machine learning model; or
classify, at the tap, the noise pattern using one or more of the artificial intelligence model or the machine learning model.

18. The device of claim 15, wherein the processing device is further operable to:
use, at the tap, historical data to predict and mitigate noise dynamically.

19. The device of claim 15, wherein the tap comprise a digital signal processor operable to apply the adaptive filter or operable to apply a notch filter.

20. The device of claim 15, wherein the tap is operable for remote monitoring.
